(19) United States
(12) Patent Application Publication
(10) Pub. No.: US 2026/0258776 A1
(43) Pub. Date: Sep. 3, 2026

(54) WAVE POWER GENERATION DEVICE AND SEA FARM

(71) Applicant: CHINA SOUTHERN POWER GRID TECHNOLOGY CO., LTD., Guangzhou, Guangdong (CN)

(72) Inventors: Taolue YANG, Guangzhou, Guangdong (CN); Shi LIU, Guangzhou, Guangdong (CN); Yi YANG, Guangzhou, Guangdong (CN); Tao TAO, Guangzhou, Guangdong (CN); Xinran GUO, Guangzhou, Guangdong (CN); Jinghui SONG, Guangzhou, Guangdong (CN); Chonggan LIANG, Guangzhou, Guangdong (CN); Hongxing WANG, Guangzhou, Guangdong (CN); Zhigang LIU, Guangzhou, Guangdong (CN); Wen CHEN, Guangzhou, Guangdong (CN); Wenjun OU, Guangzhou, Guangdong (CN); Shenghua WEI, Guangzhou, Guangdong (CN)

(73) Assignee: CHINA SOUTHERN POWER GRID TECHNOLOGY CO., LTD., Guangzhou, Guangdong (CN)

(21) Appl. No.: 18/871,542

(22) PCT Filed: Oct. 30, 2023
(86) PCT No.: PCT/CN2023/127706

§ 371 Date: Dec. 4, 2024

(30) Foreign Application Priority Data
Jul. 11, 2023 (CN) 202310845368.7
Sep. 15, 2023 (CN) 202311192407.4

(51) Int. Cl. F03B 13/18; A01K 61/00

(52) U.S. Cl. CPC F03B 13/18; A01K 61/00; F05B 2220/705

(57) ABSTRACT

Wave power generation device and sea farm are provided. The wave power generation device includes a flexible mat, a transmission module and an energy conversion module. The flexible mat has at least three vertices, and can be spread by outward tensional forces applied on the vertices. At least one of the vertices is connected with the transmission module. The energy conversion module is connected to the transmission module, to partially convert mechanical energy of the flexible mat produced under an action of wave surge into electrical energy. The flexible mat and the transmission module are cooperated to enable the flexible mat to be sufficiently spread to absorb the wave energy under the action of wave undulation of various frequencies and directions.

The present application claims the priorities to Chinese Patent Application No. 202311192407.4, titled “WAVE POWER GENERATION DEVICE AND SEA FARM”, filed with the China National Intellectual Property Administration on Sep. 15, 2023, and Chinese Patent Application No. 202310845368.7, titled “WAVE POWER GENERATION DEVICE AND SEA FARM”, filed with the China National Intellectual Property Administration on Jul. 11, 2023, the entire disclosures of which are incorporated herein by reference.

### FIELD

The present application relates to the technical field of power generation devices, and in particular to a wave power generation device and a sea farm.

### BACKGROUND

As a type of marine renewable energy, wave energy is a vital part of renewable energy strategies of China. Due to its significant advantages of large reserves, sustainability, and being green and clean, the wave energy is favored by coastal countries worldwide, and is becoming an important source of future energy supply and a new growth point for the marine economy. As a typical marine strategic emerging industry, the wave power industry has broad development prospects, which has significant practical importance in implementing the national strategy of achieving the carbon peaking and carbon neutrality goals, promoting economic structural transformation, and realizing the transformation of economic growth mode.

Wave energy is generated by large-scale periodic oscillations of water caused by sea winds. When the propagation speed of waves is lower than the wind speed above them, a pressure difference between windward and leeward sides of the waves and the shear stress produced by the friction between the wind and the sea surface cause energy to be coupled from the wind to the waves, making the waves grow continuously. The kinetic and potential energy contained in the oscillations is collectively referred to as the wave energy. According to the survey results of the World Energy Council, the globally available wave energy is up to 2 billion kW, which may significantly help to alleviate the energy crisis and reduce carbon emissions. However, many technical problems are to be solved to turn this potential energy reservoir into practically usable energy.

Due to its high energy density, the wave energy has become an important energy supply for offshore devices. At present, domestic and foreign wave power generation devices are developing towards larger scales and diversified integrations, which mainly provides electricity to coastal cities, islands, and large offshore platforms. Developed countries in Europe, America, and other regions started research on the wave power generation devices earlier, and some typical examples are as follows.

(1) The OPT (Ocean Power Technologies) Company in the United States has developed a Power Buoy point absorber device. This device utilizes the up-and-down oscillation of the absorber buoy driven by the wave undulation to drive the hydraulic power generation system. Currently, standardized designs and manufacturing for 3 kW, 7.5 kW, and 150 kW level of this device has been achieved, which are mainly used for powering marine observation instruments. For this type of device, when the size of the main body of the absorber buoy exceeds half the wavelength, it will be difficult to move in sync with the wave. Therefore, it is impossible to improve the unit power of the device by increasing the size.

(2) The WaveStar Energy Company in Denmark developed a multi-float wave power device, i.e. the Wave Star. The main structure of this device is fixed by piling, while multiple wave absorber floats absorb the wave energy to drive a hydraulic system to achieve energy conversion. The company built the first-generation prototype in 2006, which had absorber floats with a diameter of 1 m, and operated stably for nearly 2 years. In 2009, they developed a second-generation test prototype with absorber floats having a diameter of 5 m, the installed capacity is 110 kW, and the device is successfully connected to the grid in February of the following year. However, the fixed piling structure of this device limits the site selection and causes challenges in application and promotion.

(3) The Ocean Energy Company in Ireland built a prototype of a 500 kW OE Buoy wave power device of a backward bent duct type. This device uses the upward and downward movements of the wave to push air, which in turn drives a turbine to generate power. It underwent real sea testing for nearly 3 years in the small wave area of Galway Bay and the open sea areas along the Atlantic coast. While the pneumatic wave power device has a simple structure and is easy to maintain, the air turbine interacts with high-frequency reciprocating airflow directly, resulting in poor energy conversion efficiency and power quality, which cannot satisfy the demands for high-quality electricity.

(4) The Pelamis Wave Power Company in Scotland developed the Pelamis raft-type wave power device with a unit power of 750 kW, and realized the networking operation of 3 units in Aguçadoura, Portugal, with a total installed capacity of 2.25 MW. This device uses hydraulic transmission for energy transfer and has a simple mooring system. However, its width facing the waves is too small compared to its length, and thus the energy from the frontal incoming waves is small, making the device only suitable for areas with large waves.

(5) The Wello Company in Finland built the “Penguin I” prototype in 2010. This device employs a floating vessel design to absorb the kinetic energy of the waves, to drive a generator inside the vessel to rotate. It was tested at the European Marine Energy Centre and the UK's Wave Hub testing site, with favorable results. The entire device has only one moving component for energy conversion, which is located inside the vessel, effectively preventing marine biofouling and seawater corrosion, thereby reducing maintenance costs.

Wave energy development and utilization technology in China began in the late 1970s and has a research history of over 40 years. In the early stage, efforts mainly focused on fundamental theoretical research of wave energy, tracking key technologies, and developing small wave power devices. Over the past decade, with the gradual in-depth implementation of the strategy of building a maritime power in an all-round way, especially with the support of the key research and development programs of the Ministry of Science and Technology and special funds for marine renewable energy from the Ministry of Natural Resources, China's wave energy research has achieved rapid development, a series of wave power generation equipment has been developed, and some technologies have reached world-class level.

(1) In December 2019, Guangdong Power Grid Co., Ltd., as the leader of the project, together with 9 other participators including China Southern Power Grid Technology Co., Ltd., Guangzhou Institute of Energy Conversion of the Chinese Academy of Sciences, successfully obtained approval for key project titled “Research on Key Technologies of Megawatt-Level High-Efficiency and High-Reliability Wave Power Generation Devices and Demonstration on South China Sea Islands and Reefs” of the 2019 national key research and development program for renewable energy and hydrogen energy technology project. This national key research and development program project is mainly undertaken by China Southern Power Grid Technology Co., Ltd. The project team, considering the electricity demands, wave resources, the high reliability required for offshore operations, and other special requirements of the South China Sea islands and reefs, further developed a 1 MW unattended floating high-efficiency wave power generation device suitable for the South China Sea islands and reefs. Finally, and finally this device was connected to the grid to supply power to the South China Sea islands and reefs in a long term. The 1 MW wave power generation device will be stationed in the Xisha Islands for long-term operations, and at the same time, collect actual operational data and maintenance experience. This will lay the theoretical and practical foundation for the large-scale and wide application of wave power devices, thereby further enhancing the power supply capabilities for islands and reefs of China Sea, and supporting the strategic development of the ocean power.

(2) Guangzhou Institute of Energy Conversion of the Chinese Academy of Sciences has invented the Eagle-type wave power technology with China's independent intellectual property rights (with invention patents granted in China, the US, the UK, and Australia), and developed a series of 10 kW, 100 kW, 200 kW, and 500 kW wave power generation devices, realizing the real-sea testing, grid connection of offshore islands and reefs for power supply, and grid connection of remote islands for power supply of Eagle-type wave power technology, making China the first country in the world to deploy wave power generation equipment in deep and far seas and achieve grid connection. The Eagle-type wave power technology of the Guangzhou Institute of Energy Conversion of the Chinese Academy of Sciences has been selected as a representative for wave power technology of China in the International Energy Agency report for six consecutive years.

(3) Shandong University has studied point absorber wave power generation technology, built a 120 kW prototype in 2014, and conducted short-term real-sea testing in the Chengshantou sea area of Shandong Province. The National Ocean Technology Center developed a 100 kW buoyant pendulum wave power device and conducted real-sea testing on Daguan Island, Shandong Province.

(4) Ocean University of China developed a “combined oscillating buoy wave power generation device”. A 10 kW oscillating buoy wave power device, composed of an array of four absorber buoys, underwent short-term sea testing in Zhaitang Island, Shandong Province, in 2014.

(5) Zhejiang Ocean University developed a 10 kW oscillating buoy wave power device named “Haiyuan No. 1”, which underwent short-term sea testing in the Dongsha sea area of Zhujiajian Island, Zhoushan. In addition, Tsinghua University, the Institute of Electrical Engineering of the Chinese Academy of Sciences, and North China Electric Power University have all conducted a number of theoretical studies and laboratory principle verifications on oscillating buoy wave power generation devices and oscillating water column wave power generation devices. They are planning to develop full-scale prototypes.

At present, wave power generation devices under research worldwide can be substantially classified into three types based on their principles: oscillating buoy type, oscillating water column type, and overtopping type.

### 1. Oscillating Buoy Type

An oscillating buoy wave power conversion device couples the wave energy into mechanical energy of floating objects. Its working principle is: a buoy floating on the sea surface oscillates along with the up-and-down movement of the waves, and then a mechanical coupling device converts this mechanical motion into electrical energy. This device has various forms and relatively simple structures, which make it the preferred choice for floating offshore wave power applications. The advantage of the oscillating buoy wave power conversion device lies in its flexibility. It can be designed into various shapes and sizes to adapt to various wave environments. Additionally, because this device is usually small, it can be used to supply power to remote areas or offshore platforms. This device can also be assembled in an array to provide more power.

However, the drawback of the oscillating buoy wave power conversion device lies in its limited energy capture efficiency. This device can only capture the mechanical energy of the seawater close to the buoy, leaving most of the energy carried by the nearby seawater untapped. Furthermore, deploying this device in a large sea area not only costs a lot but also significantly reduces the wave power capture efficiency due to the flow field disturbances brought by adjacent buoys.

### 2. Oscillating Water Column Type

The basic principle of the oscillating water column wave power generation device is to use the water level variations caused by the wave energy to compress or release air in a chamber, thereby driving an air turbine to rotate to generate electricity. During this process, the rise and fall of the water column cause changes in air pressure, which in turn drive the rotation of the turbine. The rotating turbine produces electricity through electromagnetic induction, allowing the device to convert the wave energy into the electrical energy. The main advantage of the oscillating water column device is that it can directly utilize the wave energy without additional energy conversion steps, making its energy conversion efficiency relatively high. In addition, this device has relatively simple structures, and therefore it is relatively cheap to manufacture and maintain.

However, the oscillating water column wave power generation device also has some problems. Firstly, this device needs to be deployed near the coast, which limits the wave energy resources it can utilize. Secondly, the efficiency and installed capacity of this device are limited by the volume of the water column and the design of the turbine, making them difficult to be improved. Finally, since vital components, such as the turbine and the generator, are exposed to the marine environment, the service life and reliability of the device may be affected.

### 3. Overtopping Type

The overtopping wave power generation device stores the surging water in a relatively high reservoir, and then takes advantage of the water level difference to drive a water turbine at a lower level to generate electricity. The advantage of this manner lies in its direct energy utilization process, which needs no complicated energy conversions, thereby improving the energy conversion efficiency to some degree. However, similar to the oscillating water column type, this type of device also needs to be deployed near the coast, which limits the wave energy resources being utilized. Similarly, because of its complex structure, the installation, operation, and maintenance costs of the device are relatively high. Moreover, the overtopping wave power generation device may cause damage to the coastline and therefore restricted by environmental protection regulations in many areas.

It can be seen from the analysis of the above three types of wave energy conversion devices that, the above three types each has its unique advantages, and share many common problems and limitations. First of all, their structures are mostly made of steel, leading to large sizes, heavy weights, and poor corrosion resistance of the devices, which increase the construction, operation, and maintenance costs of the devices. Meanwhile, due to the inherent limitations of the technology, the wave absorption range of these devices is severely restricted, making it difficult to improve the wave absorption efficiency and the energy conversion efficiency, leading to relatively poor economic efficiency. In addition, many devices need to be installed at specific locations, which limits their application scope.

Although some theoretical and experimental progress has been made on the existing wave power conversion technology, it still faces many challenges in practical applications. To transfer the wave energy from a potential source into usable energy in practice, significant breakthroughs are to be made in the wave energy capture efficiency, the conversion efficiency, cost-effectiveness, environmental impact, device reliability and so on. Resolving these technical challenges is not only an important direction for wave energy research, but also one of the key topics for global renewable energy development.

### SUMMARY

An object of the present application is to overcome shortcomings of the conventional technology by providing a wave power generation device and a wave power generation sea farm, which can be widely deployed in various wave energy-rich areas, such as near-shore embankments, shallow-sea wind power plants, deep-sea floating platforms, and offshore islands and reefs, with flexible arrangement, low cost, easy implementation and simple maintenance, thereby solving the problems of a conventional wave energy conversion device, such as poor economic efficiency caused by complex structure, high cost and low efficiency.

A wave power generation device according to the present application, including a flexible mat, a transmission module and an energy conversion module, where
the flexible mat has at least three vertices, and the flexible mat is spread by outward tensional forces applied on the at least three vertices;
at least one of the at least three vertices is connected with the transmission module; and
the energy conversion module is connected to the transmission module, to partially convert mechanical energy of the flexible mat produced under an action of wave surge into electrical energy.

Preferably, the wave power generation device includes a cooperation member, where the transmission module is connected to the cooperation member, to partially convert the mechanical energy of the flexible mat produced under the action of wave surge into mechanical energy of the cooperation member, to drive the energy conversion module to generate power.

Further preferably, the cooperation member is an elastic member.

Further preferably, the cooperation member is a counterweight.

Further preferably, the counterweight is also configured for spreading the flexible mat.

Further preferably, the transmission module is connected to the at least one vertex through a first cable and
the first cable is provided with a first guide wheel, the first guide wheel is fixedly connected to an in-water structure, the in-water structure is provided with a waterproof space, and the counterweight is driven by the flexible mat under the action of wave surge to move up and down in the waterproof space.

Further preferably, the transmission module includes a sprocket and a chain engaged with each other;
a second end of the first cable is reeved around the corresponding first guide wheel and is connected to one end of the corresponding chain, and the other end of the chain is engaged with the sprocket and is connected to the corresponding counterweight;
the sprocket is fixedly connected to the in-water structure, and both the first guide wheel and the corresponding counterweight are located below the corresponding sprocket; and
the energy conversion module and the sprocket are in a transmission connection with each other.

Further preferably, a limiter is provided right above each counterweight in the waterproof space, and the limiter is fixedly connected to the in-water structure to limit a maximum height that the counterweight can be raised.

Further preferably, a buffer is provided right below the counterweight in the waterproof space, and the buffer is fixedly connected to the in-water structure.

Further preferably, the first cable is connected to the chain through a first dynamometer, and the chain is connected to the counterweight through a second dynamometer.

Further preferably, the energy conversion module includes a gearbox and a generator, the sprocket is connected to the gearbox through a first transmission shaft, and the gearbox is connected to the generator through a second transmission shaft.

Preferably, the energy conversion module includes a clutch, and the clutch is provided with a clutch push rod; and two ends of the second transmission shaft are connected to an output end of the gearbox and an input end of the clutch, respectively, and an output end of the clutch is connected to the generator through a third transmission shaft.

Further preferably, the transmission module includes a hydraulic rod, a fixed pulley, a movable pulley and a second guide wheel that is located above the first guide wheel;
one end of the hydraulic rod is connected to the corresponding counterweight, and the other end of the hydraulic rod is fixed on the in-water structure;
the fixed pulley is fixed on the in-water structure and is located above the movable pulley, and the movable pulley is fixedly connected to the counterweight;
the second end of the first cable is reeved around the first guide wheel, the second guide wheel, the movable pulley and the fixed pulley in the listed sequence, and is fixedly connected to the fixed pulley; and
the energy conversion module is connected to the hydraulic rod through a hydraulic pipeline.

Further preferably, a third dynamometer is arranged on a part of the first cable between the first guide wheel and the second guide wheel, and the hydraulic pipeline is provided with a pressure sensor.

Further preferably, a support seat is arranged right below the counterweight in the waterproof space, and the support seat is fixedly connected to the in-water structure.

Further preferably, the energy conversion module includes a hydraulic energy storage unit and a generator; and each hydraulic pipeline is connected to the hydraulic energy storage unit, and the hydraulic energy storage unit is connected to the generator through a hydraulic motor.

Further preferably, the wave power generation device includes a processing module, and the counterweight is provided with a motion sensing module configured for collecting movement data of the counterweight, where
the motion sensing module, the first dynamometer and the second dynamometer are in communication with the processing module; or,
the motion sensing module, the third dynamometer and the pressure sensor are in communication with the processing module.

Preferably, the counterweight is a water-filled counterweight with variable weight.

Preferably, a first through hole is provided in a center of the flexible mat, multiple second through holes are provided in an evenly spaced manner along a circumferential direction by taking the first through hole as a center, and a radial length of the first through hole is larger than a radial length of each of the multiple second through holes.

Preferably, multiple third through holes are evenly provided on the entire flexible mat. Preferably, a composite coating is provided on a surface of the flexible mat.

In a preferred embodiment, at least one of the vertices of the flexible mat is a first vertex, and the first vertex is a fixed point.

Preferably, the first vertex is connected with a second cable.

Preferably, the in-water structure includes a watertight platform body and multiple watertight support pile legs arranged below the platform body, and the number and positions of the support pile legs are in one-to-one correspondence with the number and positions of the vertices of the flexible mat; and
the energy conversion module is provided in the platform body, the transmission module is provided in each of the multiple support pile legs, and each of the first guide wheels is fixedly connected to a corresponding one of the multiple support pile legs.

Preferably, the in-water structure is embodied as multiple watertight tube piles, and the number and positions of the tube piles are in one-to-one correspondence with the number and positions of the vertices of the flexible mat; and
the energy conversion module and the transmission module are provided in each of the multiple tube piles, the transmission module is connected to the corresponding energy conversion module, and each of the first guide wheels is fixedly connected to a corresponding one of the multiple tube piles.

Preferably, a roller is provided on a lateral side of the counterweight of the wave power generation device.

Another object of the present application is to provide a wave power generation sea farm, including the above wave power generation device and edge nets, where
each of free edges of the flexible mat of the wave power generation device is provided with a corresponding one of the edge nets in a vertical direction, to make the flexible mat and the edge nets form a net cage; and
an upper portion of each of the edge nets is fixedly connected to the in-water structure of the wave power generation device through a third cable.

Preferably, an offshore wind turbine is arranged on the in-water structure of the wave power generation device.

It can be seen from the above technical solutions that, the present application has the following advantages.

In the wave power generation device according to the present application, by providing the flexible mat and taking the advantage of the characteristic that coupling efficiency between a flexible structure and a pulsating flow field is generally higher than wave absorption efficiency of other mechanical structures, the flexible mat and the transmission module are cooperated to enable the flexible mat to be sufficiently spread to absorb the wave energy under the action of wave undulation of various frequencies and directions. In this way, the wave absorption efficiency of the wave energy is greatly improved, thereby enhancing the power generation efficiency of the wave power generation device. Moreover, the flexible mat according to the present application is simple in structure and low in construction costs, and therefore can be deployed on a large scale, increasing the economic efficiency of the wave power generation device according to the present application. Hence, the problems of the conventional wave energy conversion device, such as complex structures, high costs, and low efficiency, which lead to poor economic efficiency can be solved, thereby enhancing the competitiveness of wave power generation in the renewable energy market.

### BRIEF DESCRIPTION OF THE DRAWINGS

For more clearly illustrating the technical solutions in the embodiments of the present application or in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a first exemplary view of a polygon flexible mat being spread according to a first embodiment of the present application;

FIG. 2 is a second exemplary view of a polygon flexible mat being spread according to the first embodiment of the present application;

FIG. 3 is a third exemplary view of a polygon flexible mat being spread according to the first embodiment of the present application;

FIG. 4 is a fourth exemplary view of a polygon flexible mat being spread according to the first embodiment of the present application;

FIG. 5 is a fifth exemplary view of a polygon flexible mat being spread according to the first embodiment of the present application;

FIG. 6 is a schematic view showing the arrangement of a flexible mat of a wave power generation device according to the first embodiment of the present application;

FIG. 7 is a first schematic view showing the arrangement of the wave power generation device according to the first embodiment of the present application;

FIG. 8 is a schematic view showing the array arrangement of the wave power generation device according to the first embodiment of the present application;

FIG. 9 is a second schematic view showing the arrangement of the wave power generation device according to the first embodiment of the present application;

FIG. 10 is a first schematic view of a flexible mat in the form of a waterproof membrane according to the first embodiment of the present application;

FIG. 11 is a schematic view showing wave energy flow around the flexible mat in FIG. 10;

FIG. 12 is a second schematic view of the flexible mat in the form of the waterproof membrane according to the first embodiment of the present application;

FIG. 13 is a schematic view showing wave energy flow around the flexible mat in FIG. 12;

FIG. 14 is a schematic view of a flexible mat in the form of a water-permeable membrane according to the first embodiment of the present application;

FIG. 15 is a schematic view showing wave energy flow around the flexible mat in FIG. 14;

FIG. 16 is a schematic view showing wave energy flow near the flexible mat;

FIG. 17 is a schematic view showing the arrangement of a wave power generation device according to a second embodiment of the present application;

FIG. 18 is a schematic view showing the arrangement of a wave power generation device according to a third embodiment of the present application;

FIG. 19 is a first schematic view showing the arrangement of a wave power generation sea farm according to a fourth embodiment of the present application;

FIG. 20 is a second schematic view showing the arrangement of a wave power generation sea farm according to the fourth embodiment of the present application; and

FIG. 21 is a schematic view showing the array arrangement of the wave power generation sea farm according to the fourth embodiment of the present application.

Reference numerals:

| | | | |
|---|---|---|---|
| 1 | flexible mat, | 2 | first vertex, |
| 3 | second vertex, | 4 | first cable, |
| 5 | first guide wheel, | 6 | transmission module, |
| 7 | counterweight, | 8 | in-water structure, |
| 9 | energy conversion module, | 10 | roller, |
| 11 | first through hole, | 12 | second through hole, |
| 13 | third through hole, | 14 | sprocket, |
| 15 | chain, | 16 | gearbox, |
| 17 | generator, | 18 | first transmission shaft, |
| 19 | second transmission shaft, | 20 | clutch, |
| 21 | third transmission shaft, | 22 | limiter, |
| 23 | buffer, | 24 | first dynamometer, |
| 25 | second dynamometer, | 26 | first processing module, |
| 27 | motion sensing module, | 28 | hydraulic rod, |
| 29 | fixed pulley, | 30 | movable pulley, |
| 31 | second guide wheel, | 32 | hydraulic energy storage unit, |
| 33 | hydraulic pipeline, | 34 | hydraulic motor, |
| 35 | third dynamometer, | 36 | pressure sensor, |
| 37 | second processing module, | 38 | support seat, |
| 39 | edge net, | 40 | third cable, |
| 41 | offshore wind turbine, | 42 | second cable, |
| 43 | tube pile, | 44 | seabed, |
| 45 | water surface. | | |

### DETAILED DESCRIPTION OF THE EMBODIMENTS

Technical solutions according to the embodiments of the present application will be described clearly and completely as follows in conjunction with the accompany drawings in the embodiments of the present application, so that purposes, characteristics and advantages of the present application can be more obvious and understandable. It is obvious that the described embodiments are only a part of the embodiments according to the present application, rather than all of the embodiments. All the other embodiments obtained by those skilled in the art based on the embodiments in the present application without any creative work belong to the scope of protection of the present application.

In the description of the present application, it should be noted that the orientation or positional relationship indicated by the terms “upper”, “lower”, “inner”, “outer”, and the like are based on the orientation or positional relationships shown in the drawings, and are merely for the convenience of describing the present application and the simplification of the description, and do not indicate or imply that the device or element referred to must have a particular orientation, or be configured and operated in a particular orientation, which therefore should not be construed as a limitation to the scope of the present application.

In addition, terms such as “first”, “second”, “third” and the like are merely for description, and should not be construed as indicating or implying relative importance, or implicitly indicate the number of technical features being referred to. In this way, the feature defined by the terms “first”, “second”, “third” may explicitly or implicitly include one or more such features, unless otherwise specifically limited.

Unless otherwise clearly specified or limited, terms “connected”, “fixed”, “arranged” and the like should be construed broadly. For example, the connection may be fixed or detachable, or may be integrated. It may be a mechanical connection, a direct connection, or an indirect connection through an intermediate medium, or may be communication of interiors of two components. The specific meanings of the above terms may be understood by those skilled in the art according to specific cases.

Compared with wind power and photovoltaic devices, the current wave power generation device involves complex technologies, and is difficult and expensive to deploy, making it hardly accepted by the market, resulting in a low commercialization process. Regarding the great wave energy reserves, how to improve the technical difficulty and the economic efficiency of the wave power generation device to achieve widespread application has become a hot topic in the field of renewable energy.

Fishermen living by the sea have the empirical knowledge that, the attenuation rate of waves is much higher at river estuaries, nearshore shoals, and traditional sheltered anchorages than in other adjacent sea areas. The common characteristic of these environments is that a thick layer of silt sediments on the seabed to form a flexible seabed. This flexible seabed couples well with wave movements. Seawater stirs the silt, and by the resulting friction between them, mechanical energy of the waves is converted into internal energy, through which the amplitude of the waves rapidly decreases.

Inspired by this, a wave power generation device is provided in a first embodiment of the present application as shown in FIG. 6, including a flexible mat 1, a transmission module 6 (not shown in the drawings) and an energy conversion module 9 (not shown in the drawings). The flexible mat 1 has at least three vertices, and the flexible mat can be spread by outward tensional forces applied on the at least three vertices. The flexible mat 1 is used to produce a flexible undulation movement underwater under an action of wave surge.

At least one of the vertices is connected with the transmission module 6. The energy conversion module 9 is connected to the transmission module 6, so that a part of mechanical energy of the flexible mat produced under the action of wave surge can be converted into electrical energy.

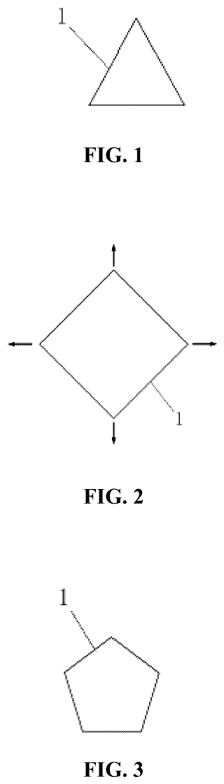

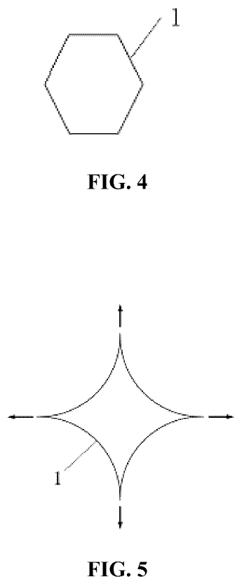

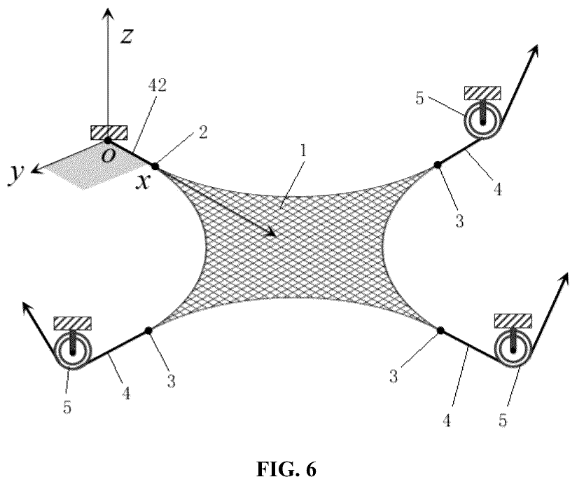

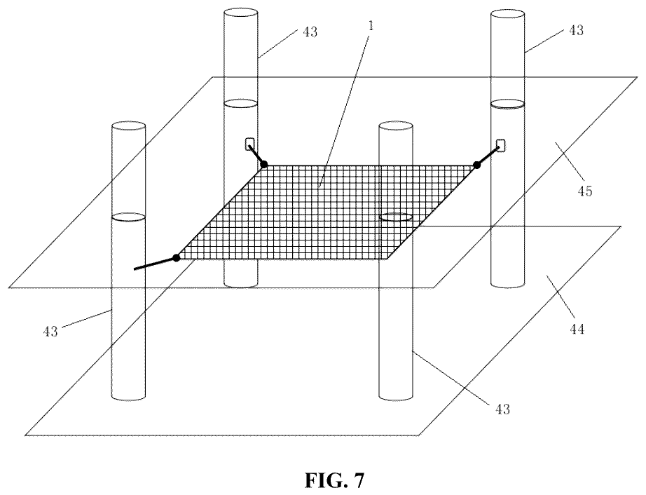

It should be noted that, the vertices in the present embodiment are not limited to intersections of edges of the flexible mat 1. It may be appreciated that, any point on the flexible mat 1 on which a tension is applied to spread the flexible mat 1 can be referred to as a vertex described in the present embodiment. Taking a case where the vertices are the intersections of the edges of the flexible mat 1 as an example, the flexible mat 1 may be a polygon, such as a triangle, a quadrilateral, a pentagon, a hexagon or the like as shown in FIGS. 1 to 4. Each edge of the polygon may be straight, or may be curved as shown in FIG. 5. Mechanical strengthening treatment may be performed to the straight or curved edges, to prevent the flexible mat 1 from being torn at a weak point of the edge.

In the flexible mat 1 according to the wave power generation device provided in the first embodiment, by providing the flexible mat 1 and taking the advantage of the characteristic that coupling efficiency between a flexible structure and a pulsating flow field is generally higher than wave absorption efficiency of other mechanical structures, the flexible mat 1 and the transmission module 6 are cooperated to enable the flexible mat 1 to be fully spread to absorb the wave energy under the action of wave undulation of various frequencies and directions. In this way, the wave absorption efficiency of the wave energy is greatly improved, and the power generation efficiency of the wave power generation device is further enhanced. Moreover, the flexible mat 1 according to the present application is simple in structure and low in construction costs, and therefore can be deployed over a large scale, increasing the economic efficiency of the wave power generation device according to the present application. Hence, the problems of the conventional wave energy conversion device, such as complex structures, high costs, and low efficiency, which lead to poor economic efficiency can be solved, thereby enhancing the competitiveness of wave power generation in the renewable energy market.

It should be noted that, the outward tensional forces applied on the flexible mat 1 for spreading the flexible mat 1 can cooperate with the movement of the flexible mat 1 along with wave undulation. The outward tensional forces may come from various sources, such as a spring assembly that can deform elastically to some degree, a hydraulic rod system with controllable oil pressure or the like. In a specific embodiment, the wave power generation device further includes a cooperation member, where the transmission module 6 is connected to the cooperation member to partially convert the mechanical energy of the flexible mat 1 produced under the action of wave surge into mechanical energy of the cooperation member, to drive the energy conversion module 9 to generate power. In the present embodiment, the transmission module 6 cooperates with the cooperation member to partially convert the mechanical energy of the flexible mat 1 produced under the action of wave surge into the mechanical energy, including kinetic energy and potential energy, of the cooperation member, and drive the energy conversion module 9 to generate power at the same time. The cooperation member may be an elastic member, and in this case, the mechanical energy of the flexible mat 1 produced under the action of wave surge may be partially converted into elastic potential energy of the elastic member. Alternatively, the cooperation member may be a counterweight 7, and in this case, the mechanical energy of the flexible mat 1 produced under the action of wave surge may be partially converted into kinetic energy and gravitational potential energy of the counterweight 7.

Further, taking the case where the cooperation member is the counterweight 7 as an example, in a preferred embodiment, the counterweight 7 is also used to spread the flexible mat 1 with its mechanical energy.

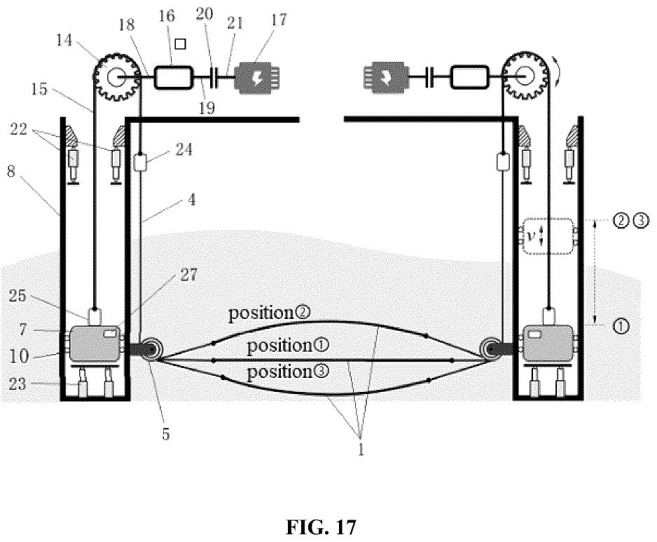

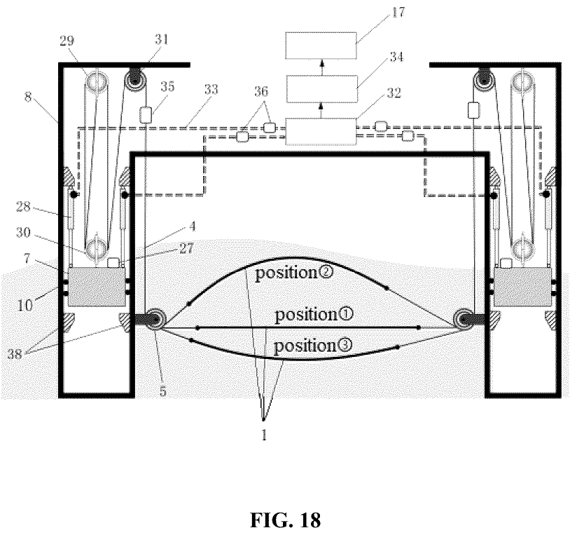

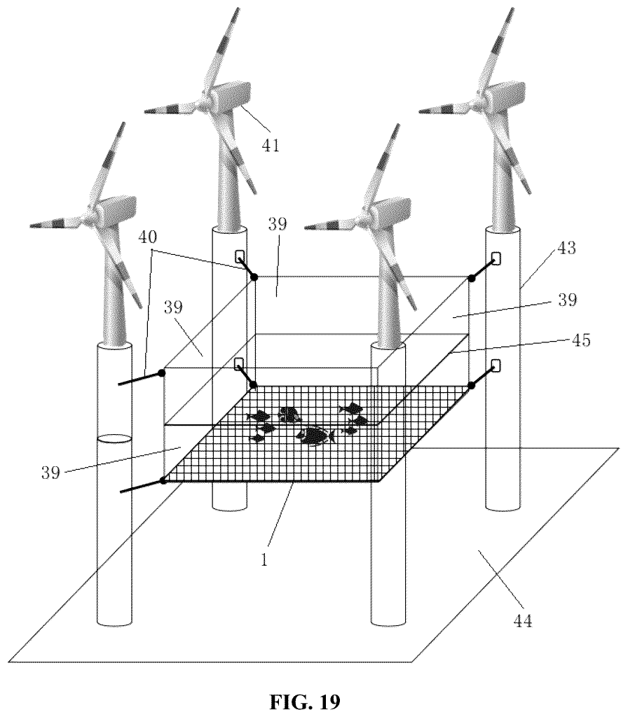

In a further preferred embodiment, as shown in FIGS. 17 and 18, the transmission module 6 is connected to each of the vertices through a first cable 4. The first cable 4 is provided with a first guide wheel 5, and the first guide wheel 5 is fixedly connected to an in-water structure 8. The in-water structure 8 is provided with a waterproof space, and the counterweight 7 is driven by the flexible mat 1 under the action of wave surge to move up and down in the waterproof space.

It should be noted that, the counterweight 7 provides a restoration tension for spreading of the flexible mat 1. It should be noted that, the restoration tension should have a proper magnitude to ensure that the counterweight 7 can smoothly move back and forth along with the wave absorbing mat being under the action of the wave undulation. Therefore, a weight of the counterweight 7 should be tuned and determined according to a weight of the flexible mat 1 and wave field intensity of the area where the device provided in the present application is mounted, so as to ensure full spreading of the flexible mat 1 and sufficient energy coupling between the flexible mat 1 and the waves, thereby ensuring the wave absorption efficiency of the flexible mat 1. In order to make it easier to adjust the weight of the counterweight 7, in the present embodiment, the counterweight 7 is a water-filled counterweight.

It should be noted that, in the present embodiment, the flexible mat 1 and the first cables 4 form a tensioned membrane structure. In order to improve coordination and consistency of movements of the vertices when the flexible mat 1 is under the action of the waves, and ensure the wave absorption efficiency of the flexible mat 1, the first cables 4 and the first guide wheels 5 are arranged in such a way that the flexible mat 1 can be kept in a balanced tensioned state when there is no wave while be always kept underwater under the action of the waves. Depths of the flexible mat 1 and the first guide wheels 5 in the water are determined according to a comprehensive analysis of spatiotemporal characteristics of the waves in the mounting area including wavelength, amplitude, frequency and the like.

The energy absorption efficiency of the flexible mat 1 is correlated with its shape and mechanical properties. The shape is designed comprehensively from the perspectives of functions, costs, efficiency and overall technical maturity. The flexible mat 1 is made of such a material that the flexible mat 1 has a high elastic modulus in two-dimensional expansion directions and can hardly be deformed, so as to ensure that the undulation movement of the flexible mat 1 can be effectively transmitted to the first cables 4. Moreover, the flexible mat 1 is sufficiently flexible in its thickness direction, so that the flexible mat 1 better follows the movement of the waves in real time to couple with and absorb the mechanical energy of the waves. As shown in FIGS. 17 and 18, the flexible mat 1 is at a position (1) when there is no wave, at another position 2 when the wave surges upwards, and at yet another position 3 when the wave surges downwards. Correspondingly, the counterweight 7 is at positions 1, 2 and 3 respectively in the waterproof space of the in-water structure 8. When moving from the position 2 to the position (1) or from the position 3 to the position 1), the counterweight 7 is able to spread the flexible mat 1. As shown in FIG. 6, which is a schematic view of a specific embodiment, the flexible mat 1 is a quadrilateral with four vertices and curved edges. Specifically, the flexible mat 1 is a lightweight fabric woven from high-strength chemical fibers and has high economic efficiency and durability. The surface of the fabric is further provided with a composite coating having composite functions of enhancing overall mechanical strength of the flexible mat 1, UV resistance, preventing marine biofouling, seawater corrosion resistance and self-cleaning. To meet the environmental protection requirements, the structure of the flexible mat 1 should have a certain degree of light transmittance and low toxicity to reduce disturbance to marine organisms, especially on photosynthesis of benthic marine organisms.

In a case that the flexible mat 1 has a small size when being spread, and only one energy conversion module is needed when the tensioned membrane structure is attached to the in-water structure 8 to be implemented offshore in practice, energy conversion can be achieved after the transmission modules are respectively connected to the energy conversion module. This case is highly practical and has high economic efficiency. The energy conversion module is shared, so that the number thereof is decreased, thereby reducing the number of large devices and the cost thereof. However, in this case, the in-water structure 8 needs to have a certain arrangement space, to enable the transmission modules to be connected to the energy conversion module. In a specific embodiment, the in-water structure 8 includes a watertight platform body and multiple watertight support pile legs arranged below the platform body, and the number and positions of the support pile legs are in one-to-one correspondence with the number and positions of the vertices of the flexible mat 1, to ensure that the flexible mat 1 can be spread horizontally. The energy conversion module 9 is arranged in the platform body, the transmission modules 6 are arranged in the support pile legs respectively, and the first guide wheels 5 are fixedly connected to the support pile legs respectively.

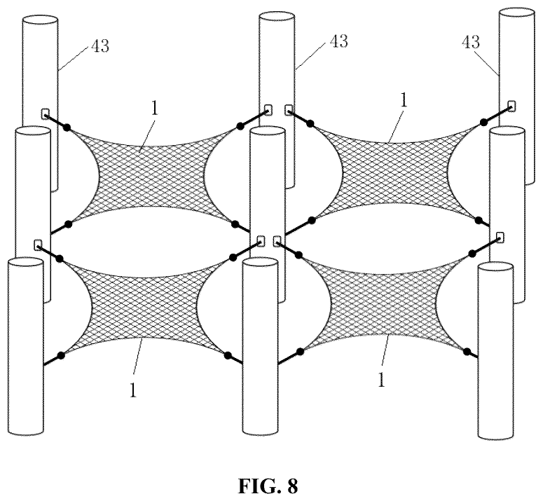

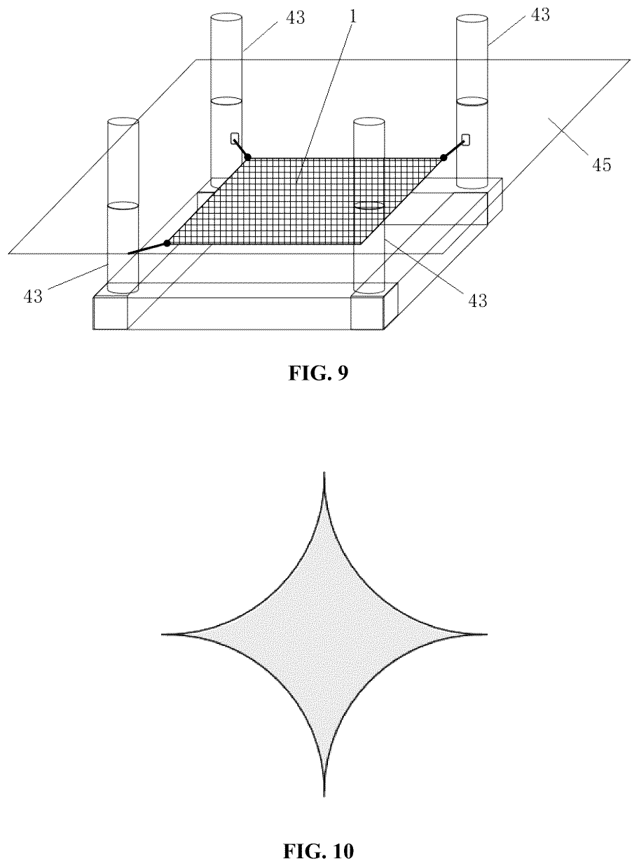

In a case that the flexible mat 1 has a relatively large size when being spread, and it is not implementable or economically efficient to employ the connection solution that the single energy conversion module is shared by all the transmission modules, or in a case that the above solution is not applicable to the spatial arrangement of the in-water structure 8, each of the transmission modules is provided with a corresponding energy conversion module. In a specific embodiment, the in-water structure 8 includes multiple watertight tube piles 43, where the number and positions of the tube piles are in one-to-one correspondence with the number and positions of the vertices of the flexible mat 1. Each of the tube piles 43 is provided with a corresponding energy conversion module 9 and a corresponding transmission module 6, and the transmission module 6 and the energy conversion module 9 located in the same tube pile 43 are connected to each other. The first guide wheels 5 are fixedly connected to the corresponding tube piles 43 respectively. In shallow sea areas, the tube piles 43 may be fixed on a seabed 44 in a manner shown in FIG. 7. With such fixation manner, the device may be deployed in an array as shown in FIG. 8 to cover a large sea area, increasing the overall installed capacity of the device. Multiple flexible mats 1 may share a same tube pile 43 to improve the utilizing rate of materials. In deep sea areas, as shown in FIG. 9, the tube piles may be supported in a floating manner by a semi-submersible floating platform, or the tube piles 43 may be combined to an offshore floating platform structure.

In the support pile leg or the tube pile 43, a roller 10 is provided on a lateral side of the counterweight 7, to prevent collision or sliding friction between the counterweight 7 and an inner wall of the support pile leg or the tube pile 43 caused by shaking of the counterweight 7 when moving up and down. The support pile leg or the tube pile 43 is typically a vertical structure, taking advantage of this feature, the roller 10 rolls on the inner wall of the support pile leg or the tube pile 43 to limit the up and down movement of the counterweight 7 along the vertical direction. Furthermore, the roller 10 turns the friction between the vertically moving counterweight 7 and the inner wall into a rolling friction, which prevents affection of the energy conversion efficiency due to excessive energy consumption.

Preferably, as shown in FIG. 6, at least one of the vertices of the flexible mat 1 is a first vertex 2, which is a fixed vertex. That is, the first vertex 2 does not move significantly along with the undulation of the flexible mat 1, and thus the flexible mat 1 is less likely to get tangled itself. Correspondingly, the vertex that moves significantly along with the undulation of the flexible mat 1 is referred to as a second vertex 3. Further, the first vertex 2 is connected with a second cable 42. The first vertex 2 is connected to one end of the second cable 42, on one hand, the first vertex 2 can be fixed by fixing the other end of the second cable 42; on the other hand, with the second cable 42, the inclination of the flexible mat 1 caused by the fixation of the first vertex 2 is alleviated, thereby improving the efficiency of the flexible mat 1 in capturing the wave energy. It should be noted that, the first vertex 2 can be fixed in various manners. The first vertex 2 may be fixed on the seabed through a connection device such as the second cable 42, or may be fixed to an offshore floating structure, as long as the first vertex 2 can be fixed compared with the second vertex 3.

Due to the mechanical coupling interaction between the flexible mat 1 and the waves, the wave energy is absorbed by the flexible mat 1 to be converted into energy in other forms. As a result, the amplitude of the sea waves within the footprint of the flexible mat 1 decreases, forming a low-energy zone of the wave energy. Seawater in a nearby high-energy zone with large amplitude outputs energy to compensate the energy consumption of seawater in the low-energy zone, forming a direction of energy flow (an energy flow direction) shown in FIG. 16, to enable the flexible mat 1 to continuously absorb the wave energy of the seawater. The absorption of the wave energy by the flexible mat 1 affects the wave flow field. Meanwhile, the mechanical effect applied on the wave absorbing mat by the flow field changes accordingly. The dynamic properties of flow field will be affected by surface hydrophilicity or hydrophobicity, microstructure and water permeability of the flexible mat 1, which further affects the energy coupling efficiency. The most important factor is the water permeability of the flexible mat 1. Based on the water permeability, the flexible mat 1 can be classified into two forms, namely a waterproof membrane and a water-permeable membrane.

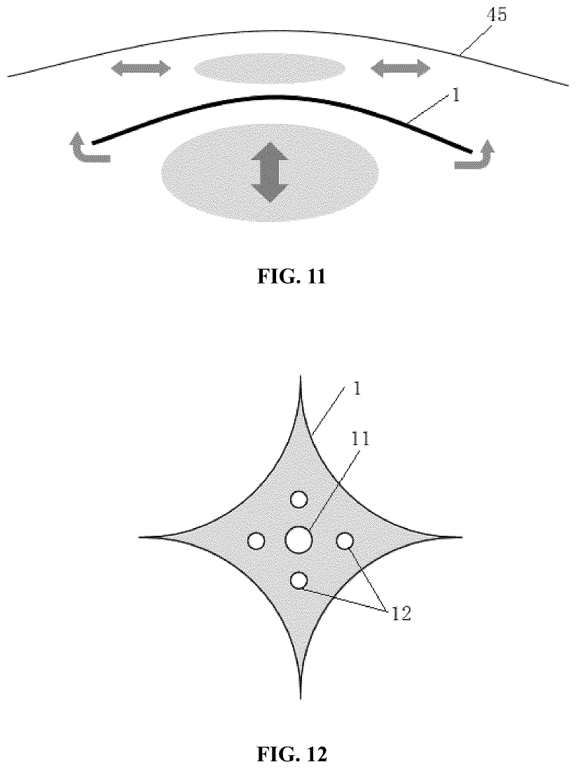

The flexible mat 1 is impacted by moving water mass formed from the waves to move up and down, capturing the wave energy. The waterproof membrane refers to a membrane through which the water cannot permeate directly on the macro level. FIG. 10 shows a specific embodiment of the waterproof membrane. According to the principle shown in FIG. 11, the seawater cannot directly permeate through the waterproof membrane, thus is partitioned into an upper part and a lower part. As a result, the mass and energy exchange between the upper and lower parts of the water are greatly suppressed, and the overall coordination and consistency of the movement are also significantly restrained. The upper part of the seawater above the flexible mat 1 are regarded as a whole. When the waves form, the seawater surges upwards from the bottom, and the flexible mat 1 captures the mechanical energy of the seawater moving upwards, while the upper part of the seawater also absorbs a part of the mechanical energy and converts it into kinetic energy and gravitational potential energy. When the waves fall back, the lower part of the seawater surges downwards, and the upper part of the seawater moves downwards, so that a part of the mechanical energy is captured by the flexible mat 1. During the formation and falling of the waves, the upper part of the seawater exchanges mass with nearby seawater only at the edges of the flexible mat 1. In a case that the flexible mat 1 covers a large area, this manner of seawater energy exchange has low overall efficiency. Moreover, the surrounding water produces turbulences when bypassing the flexible mat 1, which may cause irregular swing of the flexible mat 1, reducing the energy coupling efficiency, and affecting the pulsation pattern of the nearby seawater.

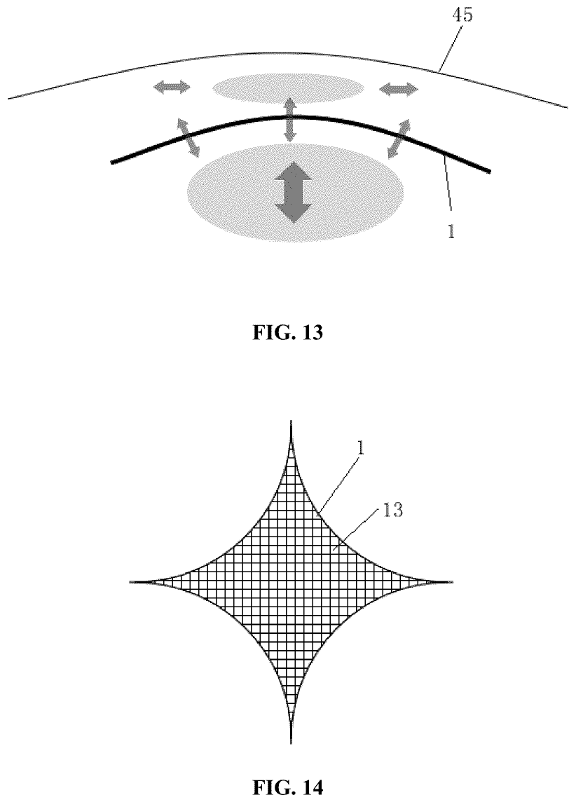

In a preferred embodiment, as shown in FIG. 12, a first through hole 11 is provided in a center of the flexible mat 1, and multiple second through holes 12 are provided in an evenly spaced manner along a circumferential direction by taking the first through hole 11 as a center, and a radial length of the first through hole 11 is larger than a radial length of each of the multiple second through holes 12. In this case, as shown in FIG. 13, during the wave undulation, the surging seawater exchanges mass and energy through the first through hole 11 and the second through holes 12 on the flexible mat 1, so that the upper and lower parts of the seawater can move in a coordinated manner, thereby effectively enhancing the movement coupling efficiency between the waves and the flexible mat 1. Meanwhile, the stable flow field in the central area increases the hydrodynamic stability of the flexible mat 1, making it more compliant with the movement of the waves, thereby preventing unstable swings caused by a large amount of water flowing around the border of the flexible mat 1. It should be noted that, the first through hole 11 and the second through holes 12 may be round, or may be of other shapes. The size and specific location of the holes on the flexible mat 1 are adaptively designed according to wave characteristics of specific sea areas.

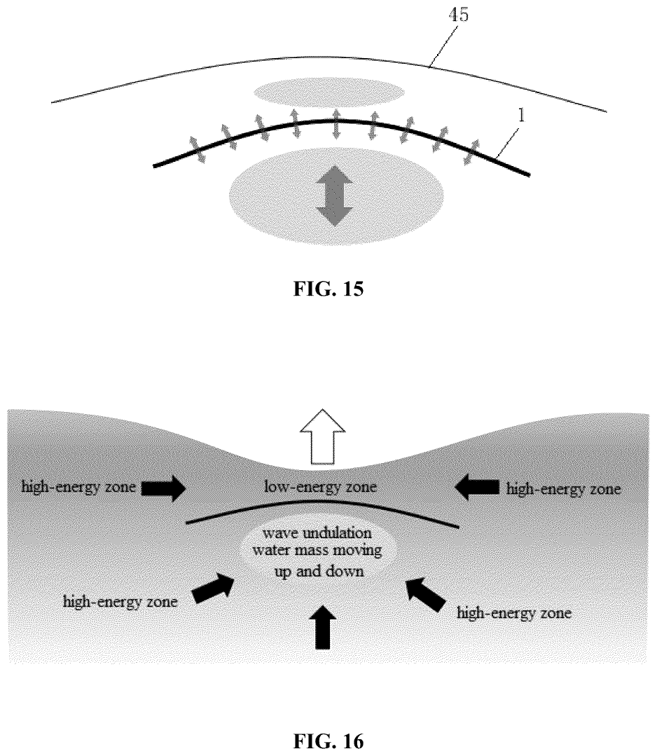

In another preferred embodiment, as shown in FIG. 14, multiple third through holes 13 are evenly distributed on the entire flexible mat 1 to form a water-permeable membrane structure. A ratio of a total area of the third through holes 13 to a total area of the flexible mat 1 is referred to as the water permeability of the flexible mat 1. For example, the water permeability of 50% implies that the water-permeable third through holes 13 occupy 50% of the area of the flexible mat 1. In the water-permeable membrane structure as shown in FIG. 15, since the upper and lower parts of the seawater relative to the flexible mat 1 can sufficiently exchange mass and energy with each other, compared with the flexible mat 1 provided with the first through hole 11 and the second through holes 12, the above flexible mat disturbs the wave pulsation pattern less, has better coupling effect with the waves, and thus the energy input efficiency of the nearby seawater is higher.

In the above embodiments, the transmission module 6 connects the first cable 4 with the counterweight 7, enabling the mechanical energy of the flexible mat 1 under the action of the wave surge to be partially converted into the mechanical energy of the counterweight 7. There are various configurations of transmission modules that can achieve these technical effects, and different configurations of transmission modules may affect the structure of the energy conversion module being connected thereto.

In view of this, another wave power generation device is provided according to a second embodiment. The second embodiment is a first specific implementation of configurations and structures of the transmission module and the energy conversion module provided based on the above embodiments.

As shown in FIG. 17, the transmission module 6 may be a chain transmission module, which specifically includes a sprocket 14 and a chain 15 engaged with each other (alternatively, the transmission module 6 may be a belt transmission module including a belt pulley for replacing the sprocket 14, and a belt for replacing the chain 15). A second end of the first cable 4 is reeved around the corresponding first guide wheel 5 and is connected to one end of the corresponding chain 15, and the other end of the chain 15 is engaged with the sprocket 14 and is connected to the corresponding counterweight 7. The sprocket 14 is fixedly connected to the in-water structure 8, and the first guide wheel 5 and the corresponding counterweight 7 are both located below the corresponding sprocket 14. The energy conversion module 9 is in a transmission connection with the sprocket 14 to convert mechanical rotation of the sprocket 14 into electrical energy.

Correspondingly, the energy conversion module 9 includes a gearbox 16 and a generator 17. The sprocket 14 is connected to the gearbox 16 through a first transmission shaft 18, and the gearbox 16 is connected to the generator 17 through a second transmission shaft 19. In this way, forward and reverse rotations of the sprocket 14 can be converted into one-way rotation of the gearbox 16 to be output to the generator 17. The gearbox 16 is preferably a continuously variable gearbox, which can always optimally match operating conditions of the sprocket 14 and the generator 17 to each other, so that the energy conversion efficiency is maximized.

In a preferred embodiment, the energy conversion module 9 further includes a clutch 20 that is provided with a clutch push rod. Two ends of the second transmission shaft 19 are connected to an output end of the gearbox 16 and an input end of the clutch 20 respectively, and an output end of the clutch 20 is connected to the generator 17 through a third transmission shaft 21. The generator 17 and the gearbox 16 can be separated from each other by pushing the clutch push rod, so as to enable individual commissioning and fault maintenance of the generator 17 or the gearbox 16.

In a preferred embodiment, a limiter 22 is provided right above each counterweight 7 in the waterproof space, and the limiter 22 is fixedly connected to the in-water structure 8 to limit a maximum height that the counterweight 7 can be raised, to prevent a displacement of the counterweight 7 from exceeding a preset displacement due to excessive amplitude of the flexible mat 1 to damage the device. A position of the limiter 22 may be determined according to historical maximum amplitude of sea waves in the sea area. Specifically, the limiter 22 may be connected to the in-water structure 8 in a detachable manner, so that the position of the limiter 22 can be adjusted timely according to practical use.

In a preferred embodiment, a buffer 23 is provided right below each counterweight 7 in the waterproof space, and the buffer 23 is fixedly connected to the in-water structure 8, so as to prevent damages to the mechanical structure due to impacts produced by the counterweight 7 when moving back to a lowest position.

In a preferred embodiment, the first cable 4 is connected to the chain 15 through a first dynamometer 24, and the chain 15 is connected to the counterweight 7 through a second dynamometer 25, to directly obtain a tensional force applied on the flexible mat 1 by the first cable 4 from the first dynamometer 24, and obtain a tensional force on the chain 15 from the second dynamometer 25. A force applied on the sprocket 14 can be obtained by calculating a difference between the two tensional forces. Preferably, the wave power generation device according to the second embodiment further includes a first processing module 26, and the counterweight 7 is provided with a motion sensing module 27 consisting of motion sensors including a displacement sensor, an accelerometer, a velocimeter and the like. The motion sensing module 27 is configured for collecting corresponding movement data of the counterweight 7. A moving state of the counterweight 7 is directly correlated with a displacement of the corresponding vertex of the flexible mat 1. therefore, the real-time movement characteristic of the flexible mat 1 can be determined based on the movement data acquired by the motion sensing module 27. The motion sensing module 27, the first dynamometer 24 and the second dynamometer 25 are all in communication with the first processing module 26. After receiving the data information from the first dynamometer 24, the second dynamometer 25 and the motion sensing module 27, the first processing module 26 can obtain the energy coupling efficiency of the flexible mat 1 by calculations and analyses.

In addition, yet another wave power generation device is provided according to a third embodiment. The third embodiment is a second specific implementation of configurations and structures of the transmission module and the energy conversion module provided based on the above embodiments.

As shown in FIG. 18, the transmission module 6 may be a pulley transmission module, which specifically includes a hydraulic rod 28, a fixed pulley 29, a movable pulley 30 and a second guide wheel 31 located above the first guide wheel 5. One end of the hydraulic rod 28 is connected to the corresponding counterweight 7, and the other end of the hydraulic rod 28 is fixed on the in-water structure 8. The fixed pulley 29 is fixed on the in-water structure 8 and is located above the movable pulley 30, and the movable pulley 30 is fixedly connected to the counterweight 7. The second end of the first cable 4 is reeved around the first guide wheel 5, the second guide wheel 31, the movable pulley 30 and the fixed pulley 29 in the listed sequence, and then fixedly connected to the fixed pulley 29. The energy conversion module 9 is connected to the hydraulic rods 28 through hydraulic pipelines 33.

Correspondingly, the energy conversion module 9 includes a hydraulic energy storage unit 32 and the generator 17. The hydraulic pipelines 33 are connected to the hydraulic energy storage unit 32, and the hydraulic energy storage unit 32 is connected to the generator 17 through a hydraulic motor 34. The weight of the counterweight 7 is adjusted by the amount of water filled in the counterweight 7, and the gravity of the counterweight 7 is transmitted to the flexible mat 1 through the first cable 4 and the pulley system to form the tensional force. The movement (from position (1) to position 2, or from position (1) to position (3) of the flexible mat 1 caused by the impact of the waves lifts the counterweight 7 upwards, and under an action of pressure, the hydraulic rod 28 pumps hydraulic oil to the hydraulic energy storage unit 32 through the hydraulic pipeline 33. During the process that the flexible mat 1 returns back to a balanced position (from position 2) to position (1), or from position 3 to position (1), the counterweight 7 falls back to the lowest position under the actions of the gravity and the waves together. During this process, the hydraulic rod 28 can also pump the high-pressure hydraulic oil to the hydraulic energy storage unit 32. As such, the hydraulic rod 28 can be retracted or stretched by vertical up and down movement of the counterweight 7. The high-pressure oil generated by the hydraulic rod 28 is in communication with the hydraulic energy storage unit 32 through the hydraulic pipeline 33, so that the wave energy captured by the flexible mat 1 is partially converted into hydraulic energy. Further, the hydraulic energy storage unit 32 drives the hydraulic motor 34 to rotate, and the hydraulic motor 34 drives the generator 17 to produce electricity. Similarly, when the flexible mat 1 moves from the position 2 to the position (1), or from the position 3 to the position (1), the counterweight 7 can spread the flexible mat 1 by utilizing its potential energy.

In a preferred embodiment, a third dynamometer 35 is arranged on a part of the first cable 4 between the first guide wheel 5 and the second guide wheel 31, and the third dynamometer is configured for monitoring the tensional force on the first cable 4. The hydraulic pipeline 33 is provided with a pressure sensor 36 for monitoring the oil pressure and an operation state of the hydraulic pipeline 33. Further, the wave power generation device according to the third embodiment includes a second processing module 37. The counterweight 7 is provided with a motion sensing module 27 configured for collecting the movement data of the counterweight 7. The motion sensing module 27, the third dynamometer 35 and the pressure sensor 36 are all in communication with the second processing module 37. After receiving the data information from the third dynamometer 35, the pressure sensor 36 and the motion sensing module 27, the second processing module 37 can obtain the energy coupling efficiency of the flexible mat 1 by calculations and analyses.

In a preferred embodiment, a support seat 38 is arranged right below the counterweight 7 in the waterproof space, and the support seat 38 is fixedly connected to the in-water structure 8, to facilitate mounting, maintenance and commissioning of the counterweight 7. The counterweight 7 is fixed by the support seat 38, which prevents the counterweight 7 from shaking severely to damage the device under extreme conditions such as strong winds, tsunamis and the like.

TABLE 1
Comparison of cost between wave power generation
device of the present application and conventional
new energy power generation device

| | Wave power | | | |
|---|---|---|---|---|
| | generation device | | | |
| | with the wave | Conventional | | |
| Power | absorbing mat | wave power | | |
| generation | of the present | generation | Wind power | Solar power |
| type | application | device | generation | generation |
| Cost | 0.2~0.3 | 0.45 | 0.48~0.63 | 4-5 |
| (RMB/ | | | | |
| kWh) | | | | |

TABLE 2
Comparison of conversion efficiency between wave
power generation device of the present application
and conventional wave power generation device

| | | | | Eagle-type of |
|---|---|---|---|---|
| Power | Wave absorbing | American | Danish | Chinese |
| generation | mat of the present | company | company | Academy of |
| type | application | OPT | WaveStar | Sciences |
| Conversion | 65% | 43% | 45% | 49% |
| efficiency | | | | |

It can be seen from the tables that, the wave power generation device provided in the present application effectively solves the universal problem of poor economic efficiency of the existing wave energy conversion device caused by complicated structure, high costs, and low efficiency.

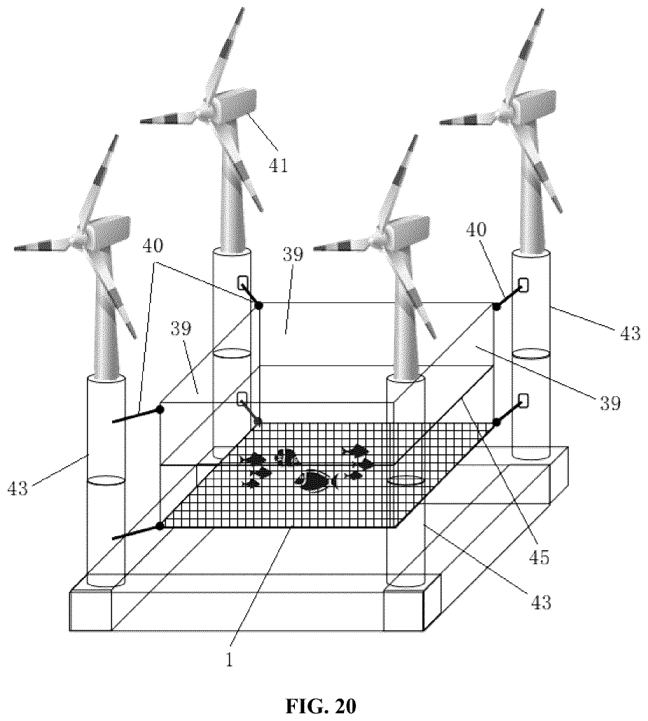

A wave power generation sea farm is provided according to a fourth embodiment. As shown in FIGS. 19 and 20, the sea farm includes the wave power generation device according to any one of the above embodiments and edge nets 39. Each of free edges of the flexible mat 1 of the wave power generation device is provided with a corresponding one of the edge nets in a vertical direction, so that the flexible mat 1 and the edge nets 39 form a net cage. An upper portion of each of the edge nets 39 is fixedly connected to the in-water structure 8 of the wave power generation device through a third cable 40. The net cage is configured for fish farming activities, to form a diverse integrated solution of “sea farm+flexible mat wave power generation”, which is beneficial to reduce the total construction cost and improve the overall utilization rate and economic efficiency of the flexible mat 1 and the in-water structure 8 in the present embodiment. It should be noted that, the edge nets 39 are light fishing nets with relatively high water permeability, which have a negligible effect on the wave flow field.

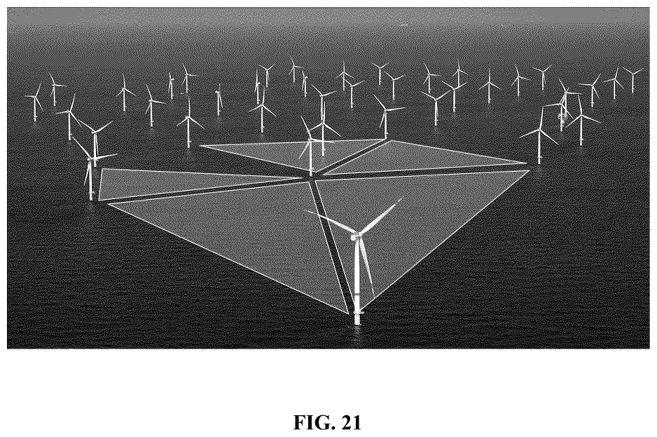

In summary, the existing wave energy conversion device generally has a small installed capacity. In view of this, in a further embodiment, an offshore wind turbine 41 is further provided on the in-water structure 8 of the wave power generation device, so as to form another diverse integrated solution of “sea farm+flexible mat wave power generation+off shore wind power generation”, which is beneficial to reduce the total construction cost and further improve the overall utilization rate and economic efficiency of the in-water structure 8 of the wave power generation device in the present embodiment, thereby making full use of the comprehensive value of the device according to the present embodiment. Specifically, by utilizing the tube pile structure of the offshore wind turbine and the intrinsic advantage of wide sea areas among the turbines, the tube pile structure of the offshore wind turbine serves as the in-water structure 8, so as to improve the installed capacity of the wave power generation device in the present embodiment. In addition, as shown in FIG. 21, the offshore wind turbines are arranged in a large expanse of sea area, which provides sufficient space for deploying the wave power generation device according to the present embodiment in an array over a wide area, so that the wave energy of the sea area can be fully utilized, thereby further enhancing the installed capacity of the wave power generation device in the present embodiment.

The above embodiments are only intended to describe the technical solutions of the present application, and not for limiting the scope of the application. Although the application has been described in detail with reference to the above embodiments, it shall be understood by those of ordinary skill in the art that the technical solutions described in the above embodiments may be modified or some technical features thereof may be substituted by equivalents, such modifications and substitutions do not depart from the scope of the technical solutions of the embodiments of the present application.

1. A wave power generation device, comprising a flexible mat, a transmission module and an energy conversion module, wherein
the flexible mat has at least three vertices, and the flexible mat is spread by outward tensional forces applied on the at least three vertices;
at least one of the at least three vertices is connected with the transmission module; and
the energy conversion module is connected to the transmission module, to partially convert mechanical energy of the flexible mat produced under an action of wave surge into electrical energy.

2. The wave power generation device according to claim 1, comprising a cooperation member, wherein the transmission module is connected to the cooperation member, to partially convert the mechanical energy of the flexible mat produced under the action of wave surge into mechanical energy of the cooperation member, to drive the energy conversion module to generate power.

3. The wave power generation device according to claim 2, wherein the cooperation member is a counterweight.

4. The wave power generation device according to claim 3, wherein the counterweight is also configured for spreading the flexible mat.

5. The wave power generation device according to claim 4, wherein
the transmission module is connected to the at least one vertex through a first cable; and
the first cable is provided with a first guide wheel, the first guide wheel is fixedly connected to an in-water structure, the in-water structure is provided with a waterproof space, and the counterweight is driven by the flexible mat under the action of wave surge to move up and down in the waterproof space.

6. The wave power generation device according to claim 5, wherein
the transmission module comprises a sprocket and a chain engaged with each other;
a second end of the first cable is reeved around the corresponding first guide wheel and is connected to one end of the corresponding chain, and the other end of the chain is engaged with the sprocket and is connected to the corresponding counterweight;
the sprocket is fixedly connected to the in-water structure, and both the first guide wheel and the corresponding counterweight are located below the corresponding sprocket; and
the energy conversion module and the sprocket are in a transmission connection with each other.

7. The wave power generation device according to claim 6, wherein a limiter is provided right above each counterweight in the waterproof space, and the limiter is fixedly connected to the in-water structure to limit a maximum height that the counterweight can be raised.

8. The wave power generation device according to claim 6, wherein a buffer is provided right below the counterweight in the waterproof space, and the buffer is fixedly connected to the in-water structure.

9. The wave power generation device according to claim 6, wherein the first cable is connected to the chain through a first dynamometer, and the chain is connected to the counterweight through a second dynamometer.

10. The wave power generation device according to claim 6, wherein the energy conversion module comprises a gearbox and a generator, the sprocket is connected to the gearbox through a first transmission shaft, and the gearbox is connected to the generator through a second transmission shaft.

11. The wave power generation device according to claim 10, wherein
the energy conversion module comprises a clutch, and the clutch is provided with a clutch push rod; and
two ends of the second transmission shaft are connected to an output end of the gearbox and an input end of the clutch, respectively, and an output end of the clutch is connected to the generator through a third transmission shaft.

12. The wave power generation device according to claim 5, wherein
the transmission module comprises a hydraulic rod, a fixed pulley, a movable pulley and a second guide wheel that is located above the first guide wheel;
one end of the hydraulic rod is connected to the corresponding counterweight, and the other end of the hydraulic rod is fixed on the in-water structure;
the fixed pulley is fixed on the in-water structure and is located above the movable pulley, and the movable pulley is fixedly connected to the counterweight;
a second end of the first cable is reeved around the first guide wheel, the second guide wheel, the movable pulley and the fixed pulley in the listed sequence, and is fixedly connected to the fixed pulley; and
the energy conversion module is connected to the hydraulic rod through a hydraulic pipeline.

13. The wave power generation device according to claim 12, wherein a third dynamometer is arranged on a part of the first cable between the first guide wheel and the second guide wheel, and the hydraulic pipeline is provided with a pressure sensor.

14. The wave power generation device according to claim 12, wherein a support seat is arranged right below the counterweight in the waterproof space, and the support seat is fixedly connected to the in-water structure.

15. The wave power generation device according to claim 12, wherein
the energy conversion module comprises a hydraulic energy storage unit and a generator; and
the hydraulic pipeline is connected to the hydraulic energy storage unit, and the hydraulic energy storage unit is connected to the generator through a hydraulic motor.

16. The wave power generation device according to claim 13, comprising a processing module, wherein
the counterweight is provided with a motion sensing module configured for collecting movement data of the counterweight; and wherein
the motion sensing module, the first dynamometer and the second dynamometer are in communication with the processing module; or,
the motion sensing module, the third dynamometer and the pressure sensor are in communication with the processing module.

17. The wave power generation device according to claim 3, wherein the counterweight is a water-filled counterweight with variable weight.

18. The wave power generation device according to claim 1, wherein a first through hole is provided in a center of the flexible mat, a plurality of second through holes are provided in an evenly spaced manner along a circumferential direction by taking the first through hole as a center, and a radial length of the first through hole is larger than a radial length of each of the plurality of second through holes.

19. The wave power generation device according to claim 1, wherein a plurality of third through holes are evenly provided on the entire flexible mat.

20. The wave power generation device according to claim 1, wherein a composite coating is provided on a surface of the flexible mat.

21. The wave power generation device according to claim 1, wherein at least one of the vertices of the flexible mat is a first vertex, and the first vertex is a fixed point.

22. The wave power generation device according to claim 21, wherein the first vertex is connected with a second cable.

23. The wave power generation device according to claim 5, wherein
the in-water structure comprises a watertight platform body and a plurality of watertight support pile legs arranged below the platform body, and the number and positions of the support pile legs are in one-to-one correspondence with the number and positions of the vertices of the flexible mat; and
the energy conversion module is provided in the platform body, the transmission module is provided in each of the plurality of support pile legs, and each of the first guide wheels is fixedly connected to a corresponding one of the plurality of support pile legs.

24. The wave power generation device according to claim 5, wherein
the in-water structure is embodied as a plurality of watertight tube piles, and the number and positions of the tube piles are in one-to-one correspondence with the number and positions of the vertices of the flexible mat; and
the energy conversion module and the transmission module are provided in each of the plurality of tube piles, the transmission module is connected to the corresponding energy conversion module, and each of the first guide wheels is fixedly connected to a corresponding one of the plurality of tube piles.

25. The wave power generation device according to claim 23, wherein a roller is provided on a lateral side of the counterweight of the wave power generation device.

26. A wave power generation sea farm, comprising the wave power generation device according to claim 1 and edge nets, wherein
each of free edges of the flexible mat of the wave power generation device is provided with a corresponding one of the edge nets in a vertical direction, to make the flexible mat and the edge nets form a net cage; and
an upper portion of each of the edge nets is fixedly connected to the in-water structure of the wave power generation device through a third cable.

27. The wave power generation sea farm according to claim 26, wherein an offshore wind turbine is arranged on the in-water structure of the wave power generation device.
